(19) United States
(12) Patent Application Publication
(10) Pub. No.: US 2026/0227922 A1
(43) Pub. Date: Aug. 6, 2026

(54) LINK STARTUP SEQUENCE MODE DETECTION FOR MEMORY SYSTEMS

(71) Applicant: Micron Technology, Inc., Boise, ID (US)

(72) Inventors: Kui Ding, Shanghai (CN); Huachen Li, Shanghai (CN); De Hua Guo, Shanghai (CN); Jun Wang, Shanghai (CN); Jia Ling Pan, Shanghai (CN)

(21) Appl. No.: 19/455,629

(22) Filed: Jan. 21, 2026

Related U.S. Application Data
(60) Provisional application No. 63/755,091, filed on Feb. 6, 2025.

(51) Int. Cl. G06F 3/06

(52) U.S. Cl. CPC G06F 3/0632; G06F 3/0611; G06F 3/0634; G06F 3/0679

(57) ABSTRACT

Methods, systems, and devices for link startup sequence (LSS) mode detection for memory systems are described. A memory system may determine a duration between signals associated with a LSS and may use the duration to determine whether the LSS is associated with a first speed mode or a second speed mode. In some examples, the memory system may perform the LSS in accordance with the determined speed mode in response to determining that the duration satisfies a threshold. Performing the LSS may involve initializing the memory system. Further, the memory system may initiate a timer in response to receiving a first signal and may stop the timer in response to receiving a second signal and determining that a channel has transitioned from a first state to a second state. The speed mode may be a low speed LSS mode or a high speed LSS mode.

### CROSS REFERENCE

The present Application for Patent claims priority to U.S. Patent Application No. 63/755,091 by Ding et al., entitled “LINK STARTUP SEQUENCE MODE DETECTION FOR MEMORY SYSTEMS,” filed February 06, 2025, which is assigned to the assignee hereof, and which is expressly incorporated by reference in its entirety herein.

### TECHNICAL FIELD

The following relates to one or more systems for memory, including link startup sequence mode detection for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports link startup sequence (LSS) mode detection for memory systems in accordance with examples as disclosed herein.

FIG. 2 shows an example of a process that supports LSS mode detection for memory systems in accordance with examples as disclosed herein.

FIG. 3 shows an example of a signal diagram that supports LSS mode detection for memory systems in accordance with examples as disclosed herein.

FIG. 4 shows an example of a signal diagram that supports LSS mode detection for memory systems in accordance with examples as disclosed herein.

FIG. 5 shows a block diagram of a memory system that supports LSS mode detection for memory systems in accordance with examples as disclosed herein.

FIG. 6 shows a flowchart illustrating a method or methods that support LSS mode detection for memory systems in accordance with examples as disclosed herein.

### DETAILED DESCRIPTION

Memory systems, such as non-volatile memory systems (e.g., NAND memory systems, UFS memory systems) may support link startup sequence (LSS) operations, which may involve one or more initialization operations and communications for startup of a link between a memory system and a host system. Memory systems supporting LSS may, in some cases, support low-speed (LS) LSS (such as in relatively older devices) and high-speed (HS) LSS (such as in relatively newer devices). In some examples, a memory system may include a dedicated LSS pin, where using a LS LSS or HS LSS mode may depend on a LSS pin state that may be controlled by a host system. Some devices, such as various memory systems or host systems, may support HSS and LSS, but may lack a dedicated LSS pin. As such, host systems and memory systems may utilize LSS in place of HSS, even if HSS is supported, as both systems may lack dedicated components to signal a LSS mode for use, which may reduce performance and increase latency in communications and operations.

According to techniques described herein, a memory system may support determining (e.g., measuring or calculating) a duration (e.g., a time interval) between signals (e.g., data bursts), and may determine (e.g., based on the duration) whether a host system is signaling in a first LSS mode (e.g., a speed mode, HS LSS mode or LS LSS mode) or a second LSS mode (e.g., the other of HS LSS mode or LS LSS mode). In some examples, the memory system may may perform the LSS in accordance with the determined LSS mode in response to determining that the duration satisfies one or more thresholds. Performing the LSS may involve initializing (e.g., re-initializing) the memory system. Further, the memory system may initiate a timer in response to receiving a first signal and may stop the timer in response to receiving a second signal and determining that a channel has transitioned from a first state (e.g., a STALL state, an inactive state, an idle state) to a second state (e.g., a BURST state, a state other than a STALL state). In some examples, relatively lower values (e.g., ~400 µs) for the duration may indicate operations in a HS LSS mode and relatively higher values (e.g., ~1600 µs) may indicate operations in a LS LSS mode.

By measuring a duration between signals to determine to operate in a particular LSS mode (e.g., a speed mode) for LSS operations, the memory system may support both higher and lower LSS modes, such as HS LSS and LS LSS modes, without the use of a dedicated LSS pin. In some examples, enabling HS LSS modes may increase both the system’s initialization speed and its performance, while reducing latency in communications and signaling. Determining a LSS mode without a dedicated LSS pin may also reduce the circuitry of the associated system, or may enable alternate uses of a pin otherwise dedicated for a LSS.

Further, such operations may enable compatibility between devices and circuitry by enabling HS LSS operations regardless of LSS pin availability. For example, a host system without a LSS pin may be backward compatible with circuitry or memory systems that include LSS pins if the memory system are able to determine the LSS mode without a LSS pin state indication. Further, a host system with a LSS pin may be forward-compatible with memory systems and circuitry not having a dedicated LSS pin if the memory systems are able to determine the LSS mode without a dedicated LSS pin. A memory system without a dedicated LSS pin may similarly be backward compatible with circuitry or host systems, and a memory system with a dedicated LSS pin may similarly be forward compatible with circuitry or host systems without a dedicated LSS pin.

In addition to applicability in memory systems as described herein, techniques for LSS mode detection may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling HS LSS in a greater quantity of memory systems in various configurations, which may improve memory speeds and subsequently may decrease processing or latency times, improve response times, or otherwise improve user experience, among other benefits.

In addition to applicability in memory systems as described herein, techniques for LSS mode detection may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by enabling backward and forward compatibility between systems supporting HS LSS mode for various combinations of LSS pin availability, improving data transfer between devices and enabling increased communications between devices, among other benefits.

Features of the disclosure are illustrated and described in the context of systems, devices, and circuits. Features of the disclosure are further illustrated and described in the context of processes, signal diagrams, and flowcharts.

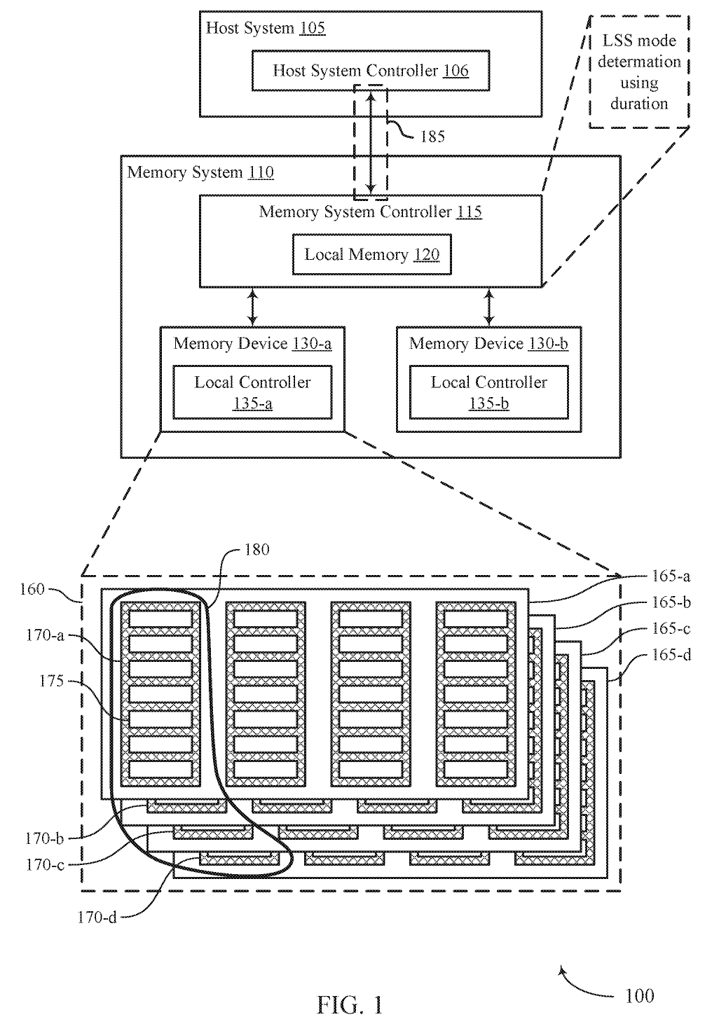

FIG. 1 shows an example of a system 100 that supports LSS mode detection for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-aand memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, the physical host interface between the memory system 110 and host system 105 may include one or more channels 185 for communications, such as one or more data channels, one or more control channels, among other channels. The physical host interface may also include one or more physical pins for the one or more channels 185. For example, one or more data channels may include a quantity of pins for data transmission. In some examples, the one or more channels 185 may include a LSS pin (e.g., a LSS state pin), which may be used for signaling a LSS mode. For example, the host system 105 may transmit a signal via a corresponding channel of the one or more channels 185 to indicate whether the host system 105 is operating in a LS LSS mode or a HS LSS mode. Some devices, such as the host system 105, the memory system 110, or corresponding circuitry (e.g., a substrate, a printed circuit board (PCB)) may lack a dedicated LSS pin. Despite lacking a dedicated LSS pin, the memory system 110 may be able to implement LS LSS regardless of HS LSS support using the techniques described herein.

The techniques described herein may support LSS mode detection by the memory system 110. For example, the memory system 110, via the memory system controller 115, may determine (e.g., measure or calculate) a duration (e.g., a time interval) between signals (e.g., data bursts) for a LSS, and may use the duration to determine whether the host system 105 is signaling in a first LSS mode (e.g., a speed mode, HS LSS mode or LS LSS mode) or a second speed mode (e.g., the other of HS LSS mode or LS LSS mode). In some examples, the memory system 110 may perform a LSS in accordance with the determined LSS mode in response to determining that the duration satisfies one or more thresholds. Performing the LSS may involve initializing (e.g., re-initializing) the memory system 110 in accordance with the determined LSS mode.

Further, the memory system may utilize a timer to determine a time at which a channel has transitioned from a first state (e.g., a STALL state, an idle state, an inactive state) to a second state (e.g., a BURST state, a state other than a STALL state), and subsequently determine the duration. In some examples, relatively lower values (e.g., ~400 µs) for the duration may indicate operations in a HS LSS mode and relatively higher values (e.g., ~1600 µs) may indicate operations in a LS LSS mode. Measuring a duration between signals to determine a mode for LSS operation may enable the memory system 110 to support operation using both HS LSS and LS LSS modes without the use of signaling via a LSS pin, increasing a speed of initialization and performance while reducing latency in communications and signaling.

The system 100 may include any quantity of non-transitory computer readable media that support LSS mode detection for memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

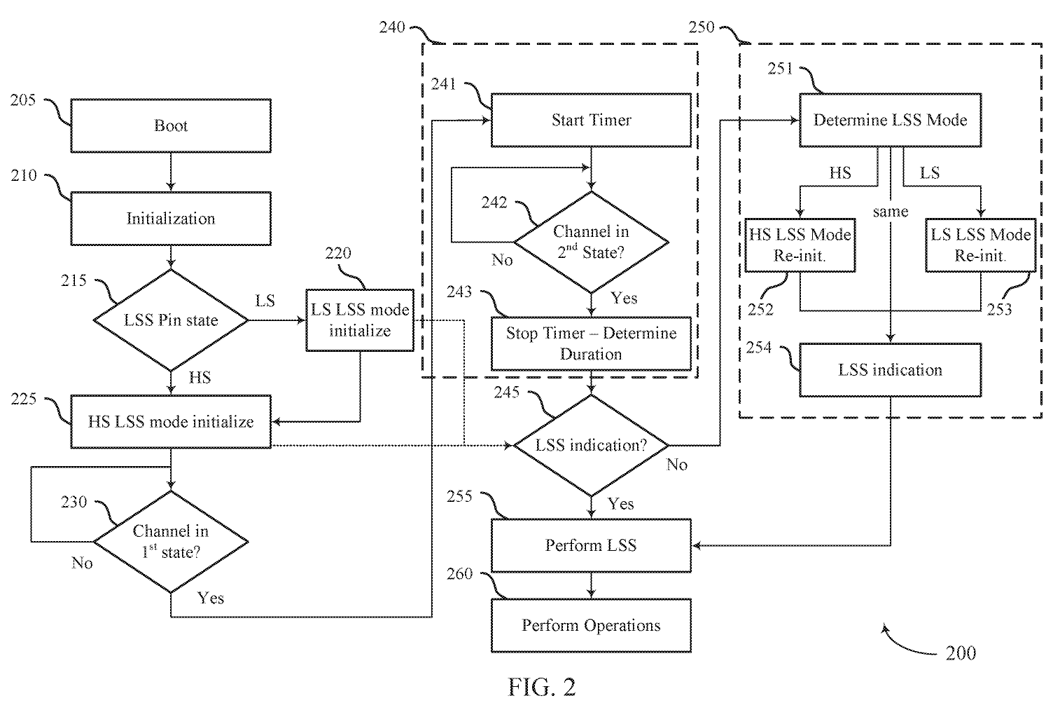

FIG. 2 shows an example of a process 200 that supports LSS mode detection for memory systems in accordance with examples as disclosed herein. One or more aspects of the process 200 of FIG. 2 may implement or may be implemented by one or more aspects of the system 100. For example, the process 200 may illustrate communications and operations performed at a memory system, such as the memory system 110 described in FIG. 1. In some examples, the process 200 may support determining whether a host system 105 is signaling in a first LSS mode or a second LSS mode.

In some examples, steps that the host system 105 performs in the process 200 can be implemented in instructions stored on memory of host system 105 and executed by the host system controller 106. Similarly, the steps that memory system 110 performs in the process 200 may be implemented in instructions or firmware stored on memory of system 110 (e.g., in a memory device 130) and executed by the memory system controller 115 (and/or local controller(s) 135).

FIG. 2 may illustrate a procedure, or method, for performing a LSS at a memory system. For example, some memory systems may include devices (e.g., non-volatile memory devices such as NAND memory devices, UFS memory devices) that support a LS LSS mode, while other memory systems may include devices (e.g., non-volatile memory devices such as NAND memory devices, UFS memory devices) that support both a HS LSS mode and a LS LSS mode. Additionally, or alternatively, some memory systems may support HS LSS but not LS LSS. In some cases, a LSS mode in which a memory system operates may depend on a LSS pin state, which may be controlled by a host system.

At 205, one or more devices may boot up. For example, the memory system 110 may boot up (e.g., power up). At 210, one or more initialization procedures may be performed. For example, the memory system 110 may perform one or more initialization procedures for the one or more memory devices.

At 215, a determination may be made on whether a LSS pin indicates a LS LSS mode or a HS LSS mode. For example, the memory system 110 may determine whether a LSS pin indicates a LS LSS mode or a HS LSS mode. In some examples, the host system 105 may pull up a LSS pin (e.g., apply a relatively higher voltage signal) to indicate that both the host system 105 and the memory system 110 are to perform a HS LSS (e.g., a HS LSS mode), and may pull down the LSS pin (e.g., apply a relatively lower voltage signal) to indicate that both the host system 105 and the memory system 110 are to perform a LS LSS (e.g., a LS LSS mode).

At 220, an LS LSS mode may be initialized if the LSS pin state is determined to indicate a LS LSS mode. For example, the memory system 110 may initialize itself (e.g., initialize M-PHY) to operate with a LS LSS mode, and to run at a relatively lower speed for the LS LSS mode.

At 225, an HS LSS mode may be initialized if the LSS pin state is determined to indicate a HS LSS mode. For example, the memory system 110 may initialize itself (e.g., initialize M-PHY) to operate with a HS LSS mode, and to run at a relatively higher speed for the HS LSS mode. After initialization, the method may proceed to 245.

At 245, a determination may be made of whether a LSS indication is received via one or more signals. For example, the memory system 110 may determine whether a LSS indication is received via one or more signals. The method may proceed to 245 after detecting a LSS indication for the LSS mode.

At 255, a LSS may be performed. For example, the memory system 110 may perform a LSS. At 260 one or more operations may be performed. For example, the memory system 110 may perform one or more additional operations (e.g., continue firmware tasks).

In some cases, the host system 105 may have the ability to perform a HS LSS but may lack a dedicated LSS pin (e.g., on a forward-compatible mobile platform). However, if the host system 105 performs HS LSS without a dedicated LSS pin (e.g., without pulling up LSS pin or without including a LSS pin), the memory system 110 may fail to detect or receive a LSS pin signal. In some cases, the memory system 110 may interpret a lack of detection of a LSS pin signal at 215 as a low value for a LSS pin, may detect a LSS pin as low in response to a missing LSS pin signal, or may default to a LS LSS for no signal detection, and the method may proceed to initialize a LS LSS mode at 220. The memory system 110 may similarly determine a LS LSS mode indication at 245 in response to a lack of detection of a LSS pin signal, or in response to a low LSS pin signal, and may perform a LS LSS at 255. Further, circuitry connecting the host system 105 and the memory system 110 may lack a dedicated LSS pin, similarly preventing LSS mode indications. The failure of the memory system 110 to detect a LSS indication and subsequent utilization of a LS LSS mode may reduce performance and increase latency in communications and operations.

In some examples, devices (e.g., non-volatile memory devices such as NAND memory devices, UFS memory devices) of a memory system may support recognizing a HS LSS mode without a dedicated LSS pin. In some cases, the memory system 110 may detect (e.g., automatically detect) a LSS mode by determining (e.g., measuring, calculating) a duration between signals as described herein. For example, a duration (e.g., PA_TActivate Time) between two data bursts may be different for a LS LSS mode and a HS LSS mode. For example, the duration may be a relatively higher value for a LS LSS mode (e.g., ~1600 µs) and may be a relatively lower value for a HS LSS mode (e.g., ~400 µs). In some cases, the memory system 110 may measure or calculate the duration between data bursts received from the host system 105 during a first LSS phase (e.g., firmware may measure PA_TActivate Time by monitoring a state of a channel). The memory system 110 may use the measured or calculated duration to determine whether the host system 105 is operating in a LS LSS mode or a HS LSS mode. In some cases, FIG. 2 may illustrate one or more procedures for determining the LSS mode using the duration. For example, the method, instead of proceeding to 255 after 220 and 225, may instead proceed to 230.

At 230, one or more channels may be monitored and a determination of whether a channel is in a first state may be made. For example, the memory system 110 may monitor one or more channels, such as a data channel shared with the host system 105 (e.g., one or more receive lanes). The memory system 110 may determine whether the channel is in a first state or a second state, and may continue monitoring the channel at 230 until the memory system 110 detects that the channel is in a first state (e.g., e.g., a STALL state, an inactive state, an idle state). In some examples, the memory system 110 may receive a first signal and may determine that the channel transitions (or is to transition) to the first state after receiving the first signal, after which the method may proceed to 240. In some examples, the memory system 110 may determine that the channel has transitioned (or is to transition) from a second state corresponding to the first signal (e.g., a high state, a BURST state) to the first state.

At 240, a duration (e.g., PA_TActivate Time) may be determined between receiving the first signal and receiving another signal. For example, the memory system 110 may determine the duration.

At 241, a timer may be initiated. For example, the memory system 110 may begin counting time after the channel transfers to the first state (e.g., a STALL state) by initiating a timer in response to receiving the first signal.

At 242 a channel may be monitored. For example, the memory system 110 may monitor the channel (e.g., via the memory system 110) to determine whether the channel has transitioned from the first state to a second state (e.g., from a STALL state to a BURST state). In some cases, the memory system 110 may receive a second signal and determine that the channel has transitioned to the second state (for example, to BURST state in response to receiving the second signal), and the method may proceed to 243.

At 243, the timer may be stopped. For example, the memory system 110 may stop the timer. In some cases, the channel may be operating in accordance with the first state (e.g., STALL state, the inactive state, the idle state) during a period of time in which the first signal and the second signal are received. Further, the first signal and the second signal may be associated with initiating the LSS (e.g., may be UFS UPR0 frames). In some examples, the memory system 110 may determine the duration, where the duration may correspond to a value of the timer after stopping the timer.

At 245, a LSS indication may be determined. For example, the memory system 110 may determine whether a LSS indication is received, and the method may proceed to 250 if a LSS indication is not received, such as if the host system 105 lacks a dedicated LSS pin or fails to pull up a dedicated LSS pin.

At 250, a determination of a LSS mode may be made and the memory system 110 may be initialized (e.g., re-initialized). For example, the memory system 110 may determine the LSS mode.

At 251, a determination may be made of whether the LSS is associated with a HS LSS mode or a LS LSS mode. For example, the memory system 110 may determine whether the LSS is associated with a HS LSS mode or a LS LSS mode in accordance with the measured duration between receiving the first signal and the second signal. In some examples, one or more lanes (e.g., receive lanes, reception lanes) of a data channel may remain in a STALL state for a relatively longer duration before exiting to a BURST state, which may indicate that the host system 105 is operating in accordance with a LS LSS. Otherwise, if the receive lanes remain in a STALL state for a relatively shorter duration before exiting to the BURST state, the duration may indicate that the host system 105 is operating in accordance with a HS LSS.

In some cases, the memory system 110 may utilize one or more thresholds to determine the LSS mode. For example, the memory system 110 may determine the HS LSS mode if a first threshold is satisfied (e.g., the duration is below a threshold of 400 µs, the duration is within a threshold time of 400 µs, the duration is within a range of time values including 400 µs). Additionally, or alternatively, the memory system 110 may determine the LS LSS mode if a second threshold is satisfied (e.g., the duration is above a threshold of 1600 µs, the duration is within a threshold time of 1600 µs, the duration is within a range of time values including 1600 µs). Further, additional examples of thresholds and ranges may be utilized to differentiate between a LS LSS mode and a HS LSS mode.

At 252, the memory system 110 may be initialized to operate in accordance with a HS LSS mode. For example, if a HS LSS mode is determined, the memory system 110 may initialize (e.g., re-initialize) itself (e.g., an M-PHY of the memory system 110 may be re-initialized by the memory system controller 115 per PA_TActivate Time) to operate in accordance with the HS LSS mode.

At 253, the memory system 110 may be initialized to operate in accordance with a LS LSS mode. For example, if a LS LSS mode is determined, the memory system 110 may initialize (e.g., re-initialize) itself to operate in accordance with the LS LSS mode. In another example, if the memory system 110 is operating in accordance with a same LSS mode as the determined LSS mode, re-initializing may be skipped and the method may proceed to 254.

At 254, a channel may be monitored for an LSS indication. For example, the memory system 110 may monitor a channel (e.g., wait to receive) until a LSS indication is received. At 255, after receiving a LSS indication, the memory system 110 may perform the LSS in accordance with the determined LSS mode, and the memory system 110 may perform one or more operations at 260 in accordance with the determined LSS mode after the initialization performed at 252 or 253. Additionally, or alternatively, in some examples the memory system 110 may skip the measurements performed at 240 and the determination and initialization performed at 250 if the memory system 110 is operating in accordance with a same LSS mode as the host system 105 before 240.

In some examples, using a duration between signals to determine a LSS mode may enable the memory system 110 to support both a HS LSS mode and a LS LSS mode without a dedicated LSS pin, enabling increased operational speed and reduced latency as well as a more flexible system. For example, such methods may enable the host system 105 to successfully establish a HS LSS with one or more devices of the memory system 110 without a dedicated LSS pin. Further, such techniques may enable backward and forward compatibility with various host systems as well as circuitry (e.g., a substrate, a printed circuit board (PCB)). Additionally, or alternatively, determining a HS LSS mode using the duration may allow for the memory system 110 to not have a dedicated LSS pin, which may save space and reduce material costs and die area and circuitry associated with one or more devices, or may enable the memory system 110 to repurpose a pin for other signaling. Lack of LSS signaling may also reduce power consumption at one or more devices.

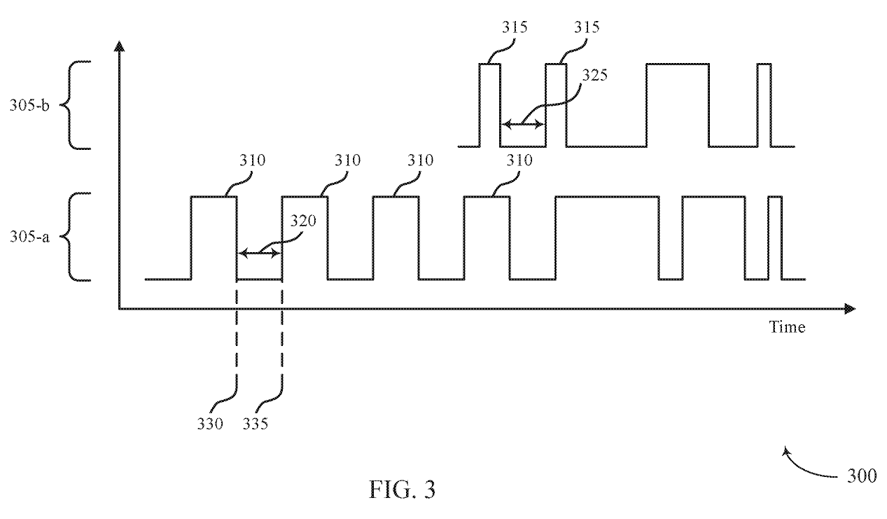

FIG. 3 shows an example of a signal diagram 300 that supports LSS mode detection for memory systems in accordance with examples as disclosed herein. One or more aspects of the signal diagram 300 of FIG. 3 may implement or may be implemented by one or more aspects of the system 100 and the process 200. For example, the signal diagram 300 may illustrate communications between the host system 105 and the memory system 110 to support determining a LSS mode as described herein with respect to FIGS. 1 and 2. In some examples, the signal diagram 300 may illustrate signaling associated with a LS LSS mode as described herein. For example, the signal diagram 300 may illustrate signaling associated with a channel between the memory system 110 and the host system 105, such as a data channel. In some cases, the host system 105 may include one or more transmission lanes 305-a and associated signaling illustrated in FIG. 3, whereas the memory system 110, or one or more devices of the memory system 110, may include one or more transmission lanes 305-b (e.g., device transmissions lanes). In some examples, operations performed by the host system 110 and the memory system 110 may be performed by the host system controller 106 and the memory system controller 115 (and/or local controller(s) 135), respectively.

In some cases, the host system 105 may transmit one or more signals as part of a first LSS phase. For example, the host system 105 may transmit one or more signals 310, which may each represent a data burst associated with triggering a LSS at the memory system 110 (e.g., UPR0 signals). In some examples, a first channel (e.g., a data channel) for transmissions from the host system 105 to the memory system 110 may be in a first state (e.g., a BURST state) during each signal 310, while in between each signal 310, the first channel may instead be in a second state (e.g., a STALL state, an idle state, an inactive state). In some examples, a first state may involve one or more relatively high and relatively low voltage levels associated with data burst transmissions and a second state may involve only relatively low voltage levels (e.g., no transmissions). In some cases, the host system 105 may transmit the one or more signals 310 via the first channel until the host system 105 receives a response from the memory system 110. For example, in response to the signal(s) 310, the memory system 110 may transmit one or more signals 315 via a second channel for transmissions from the memory system 110 to the host system 105 (e.g., UPR0 signals transmitted in response via a data channel).

Each instance of a second state may be associated with a duration (e.g., PA_TActivate Time). For example, there may be a duration 320 for a second state following a signal 310 transmission, and similarly a duration 325 (e.g., a same or different duration) for a second state following a signal 315 transmitted by the memory system 110. For example, the first channel or the second channel may remain in a second state for a minimum time associated with the duration 320 or the duration 325, respectively.

To determine whether the host system 110 is operating in a HS LSS mode or a LS LSS mode, the memory system 110 may measure one or more durations 320. For example, the memory system 110 may start a timer at 330, for example, after the channel transitions to a second state following a first signal 310. The memory system 110 may stop the timer at 335, for example, once the channel transitions back to the first state following reception of a second signal 310, and may determine a duration 320 using the timer value. In the example of FIG. 3, the memory system 110 may determine that a duration 320 corresponds to a relatively longer duration (e.g., ~1600 µs), for example, by comparing a measured duration 320 to one or more thresholds (e.g., a minimum value of 1600 µs for PA_TActivate Time), and may determine that the LSS mode is a LS LSS mode.

In some examples, the memory system 110 may transmit one or more signals 315, which may indicate that the memory system 110 performed the LSS in accordance with the LS LSS mode. For example, after determining the LSS mode and, in some cases re-initializing in the LSS mode, the memory system 110 may monitor for (e.g., wait for reception of) a LSS indication via additional signals 310, and may transmit signals 315 in response. The memory system 110 may, after transmitting the signals 315, perform LSS accordingly, and may perform one or more operations. In some cases, the memory system 110 may refrain from transmitting one or more signals 315 until after determining the LSS mode. For example, the memory system 110 may be unable to determine or decode the signals 310 if in a different mode than the host system 105 (e.g., the memory system 110 may be operating according to a HS LSS Mode and the host system 105 may be operating according to a LS LSS mode). If the memory system 110 is already in a LS LSS mode, the memory system 110 may measure a duration 320, or in some cases may skip measuring a duration 320, as the memory system 110 may successfully decode the signals 310. In other examples, the memory system 110 may measure any instance of a first state after any signal 310, or may continue to measure instances of a first state and may determine a LSS mode using one or multiple measurements.

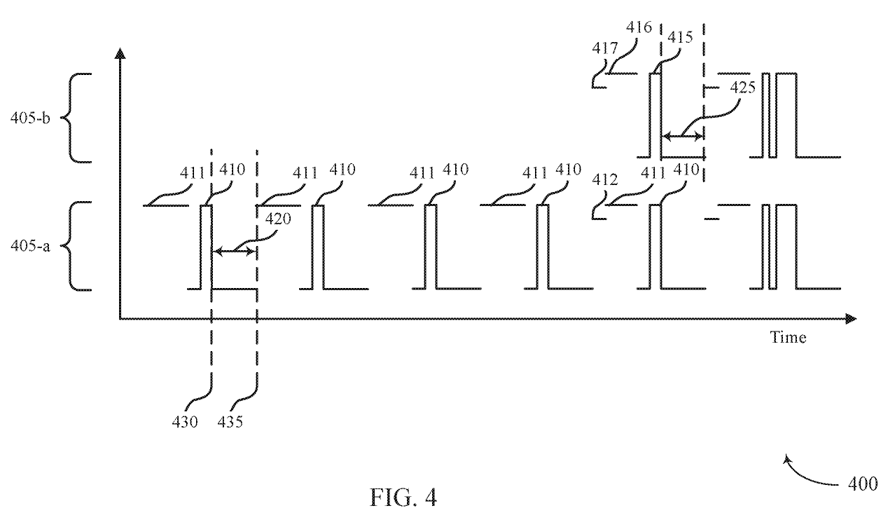

FIG. 4 shows an example of a signal diagram 400 that supports LSS mode detection for memory systems in accordance with examples as disclosed herein. One or more aspects of the signal diagram 400 of FIG. 4 may implement or may be implemented by one or more aspects of the system 100, the process 200, and the signal diagram 300. For example, the signal diagram 400 may illustrate communications between the host system 105 and the memory system 110 described in FIG. 1. In some examples, the signal diagram 400 may illustrate signaling associated with a HS LSS mode as described herein. For example, the signal diagram 400 may illustrate signaling associated with channels between the memory system 110 and the host system 105, such as one or more data channels. In some cases, the host system 105 may include one or more transmission lanes 405-a and associated signaling illustrated in FIG. 4, whereas the memory system 110, or one or more devices of the memory system 110, may include one or more transmission lanes 405-b (e.g., device transmission lanes). In some examples, operations performed by the host system 110 and the memory system 110 may be performed by the host system controller 106 and the memory system controller 115 (and/or local controller(s) 135), respectively.

In a HS LSS mode, the host system 105 may transmit one or more signals 410 (e.g., data bursts, UPR0) followed by instances of a first state (e.g., a STALL state) with a duration 420 (e.g., a minimum PA_TActivate Time), and the memory system 110 may respond with one or more signals 415 (e.g., responsive data bursts, UPR0) with a duration 425. In some cases, the host system 105 may transmit additional signaling 411 and/or 412 before a next signal 410 is transmitted (for example, after an instance of a first state and before transmitting a next signal 410).

To determine whether the host system 110 is operating in a HS LSS mode or a LS LSS mode, the memory system 110 may measure the duration 420. For example, the memory system 110 may start a timer at 430, for example, after a channel transitions to a first state following a first signal 410. The memory system 110 may stop the timer at 435, for example, once the channel transitions from a first state to a different state (e.g., a second state) following reception of signaling 411, and may determine the duration 420 using the timer value. In the example of FIG. 4, the memory system 110 may determine that the duration 420 corresponds to a relatively shorter duration (e.g., ~400 µs), for example, by comparing a measured duration 420 to one or more thresholds (e.g., a minimum value of 400 µs for PA_TActivate Time and less than a threshold of 1600 µs) and may determine that the LSS mode is a HS LSS mode.

In some examples, the memory system 110 may transmit one or more signals 415, 416, and/or 417, which may indicate that the memory system 110 performed the LSS in accordance with the HS LSS mode. For example, after determining the LSS mode and, in some instances re-initializing in the LSS mode, the memory system 110 may monitor for (e.g., wait for reception of) a LSS indication via additional signals 410, and may transmit signals 415 (e.g., UPR0), 416, and 417 in response. The memory system 110 may, afterward, perform LSS accordingly and perform one or more operations.

In some cases, the memory system 110 may refrain from transmission of one or more signals until after determining the HS LSS mode. For example, the memory system 110 may be unable to determine or decode the signals 410 if operating in a different mode than the host system 105 (e.g., the memory system 110 may be in a LS LSS Mode and the host system 105 may be in a HS LSS mode). If the memory system 110 is already in a HS LSS mode, the memory system 110 may measure the duration 420, or in some cases may skip measuring the duration 420 as the memory system 110 may successfully decode the signals 410. Additional to, or alternative to, a first instance of a first state after a first signal 410, the memory system 110 may measure any instance of a first state after any signal 410, or may continue to measure instances of a first state and may determine a LSS mode using one or multiple measurements.

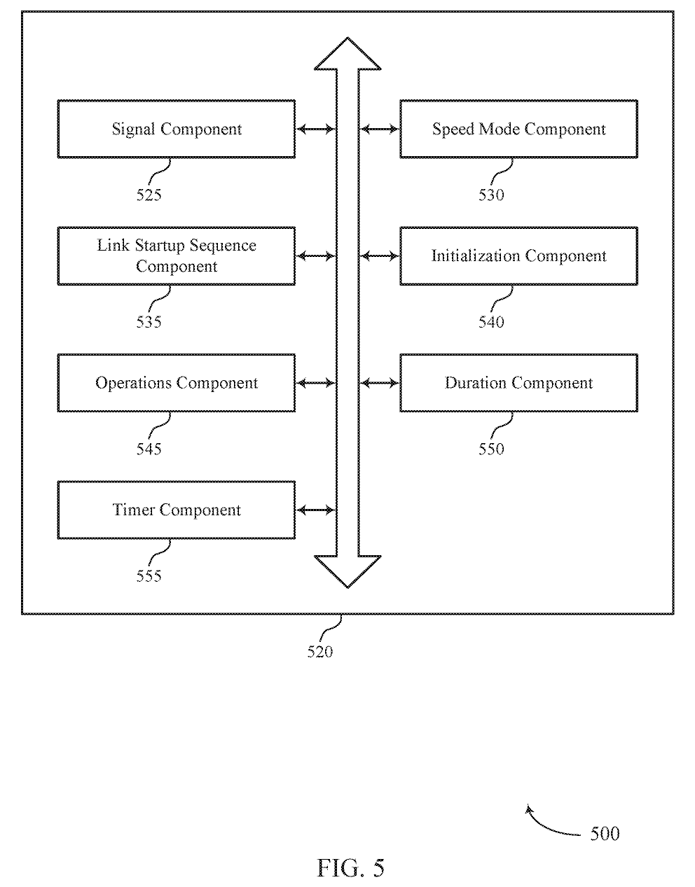

FIG. 5 shows a block diagram 500 of a memory system 520 that supports LSS mode detection for memory systems in accordance with examples as disclosed herein. The memory system 520 may be an example of aspects of a memory system as described with reference to FIGS. 1 through 4. The memory system 520, or various components thereof, may be an example of means for performing various aspects of LSS mode detection for memory systems as described herein. For example, the memory system 520 may include a signal component 525, a speed mode component 530, a LSS component 535, an initialization component 540, an operations component 545, a duration component 550, a timer component 555, or any combination thereof. Each of these components, or components of subcomponents thereof (e.g., one or more processors, one or more memories), may communicate, directly or indirectly, with one another (e.g., via one or more buses).

The signal component 525 may be configured as or otherwise support a means for receiving a first signal and a second signal each associated with a LSS. The speed mode component 530 may be configured as or otherwise support a means for determining whether the LSS is associated with a first speed mode or a second speed mode in accordance with a duration between receiving the first signal and the second signal. The LSS component 535 may be configured as or otherwise support a means for performing the LSS in accordance with the first speed mode in response to determining that the duration between receiving the first signal and the second signal satisfies a first threshold.

In some examples, to support performing the LSS in accordance with the first speed mode, the initialization component 540 may be configured as or otherwise support a means for initializing the memory system to operate in accordance with the first speed mode.

In some examples, the operations component 545 may be configured as or otherwise support a means for performing one or more operations in accordance with the first speed mode after initializing the memory system to operate in accordance with the first speed mode.

In some examples, the signal component 525 may be configured as or otherwise support a means for receiving a third signal and a fourth signal associated with a second LSS. In some examples, the speed mode component 530 may be configured as or otherwise support a means for determining whether the second LSS is associated with the first speed mode or the second speed mode in accordance with a second duration between receiving the third signal and the fourth signal. In some examples, the duration component 550 may be configured as or otherwise support a means for determining that the second duration between receiving the third signal and the fourth signal satisfies a second threshold. In some examples, the LSS component 535 may be configured as or otherwise support a means for performing the second LSS in accordance with the second speed mode in response to determining that the second duration between receiving the third signal and the fourth signal satisfies the second threshold.

In some examples, the first signal and the second signal are received via a channel coupled with the memory system and a host system, and the duration component 550 may be configured as or otherwise support a means for determining the duration between receiving the first signal and receiving the second signal.

In some examples, the first signal and the second signal are associated with initiating the LSS.

In some examples, the timer component 555 may be configured as or otherwise support a means for initiating a timer in response to receiving the first signal. In some examples, the timer component 555 may be configured as or otherwise support a means for stopping the timer in response to receiving the second signal and determining that the channel has transitioned from a first state to a second state, where the duration corresponds to a value of the timer after stopping the timer.

In some examples, the channel is operating in accordance with the first state during a period of time in which the first signal and the second signal are received.

In some examples, the first speed mode includes a high speed mode and the second speed mode includes a low speed mode.

In some examples, the first speed mode includes a low speed mode and the second speed mode includes a high speed mode.

In some examples, to support performing the LSS, the signal component 525 may be configured as or otherwise support a means for transmitting a fifth signal to a host system in accordance with performing the LSS, the fifth signal indicating that the memory system performed the LSS in accordance with the first speed mode.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

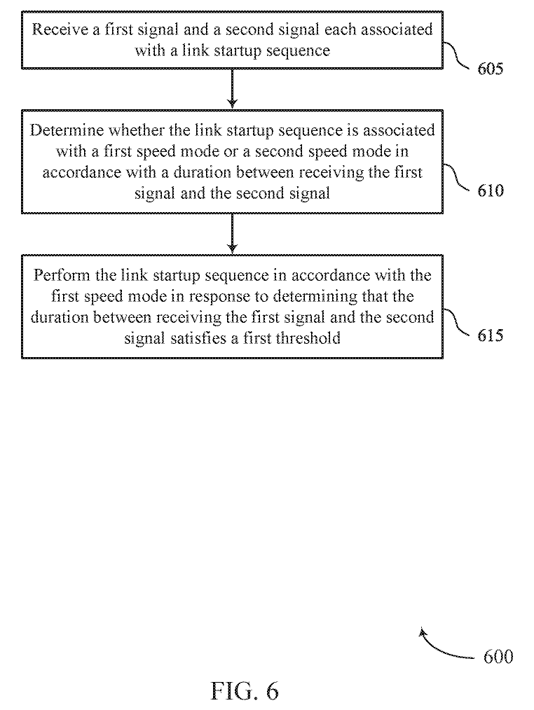

FIG. 6 shows a flowchart illustrating a method 600 that supports LSS mode detection for memory systems in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving a first signal and a second signal each associated with a link startup sequence. In some examples, aspects of the operations of 605 may be performed by a signal component 525 as described with reference to FIG. 5.

At 610, the method may include determining whether the link startup sequence is associated with a first speed mode or a second speed mode in accordance with a duration between receiving the first signal and the second signal. In some examples, aspects of the operations of 610 may be performed by a speed mode component 530 as described with reference to FIG. 5.

At 615, the method may include performing the link startup sequence in accordance with the first speed mode in response to determining that the duration between receiving the first signal and the second signal satisfies a first threshold. In some examples, aspects of the operations of 615 may be performed by a LSS component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first signal and a second signal each associated with a LSS; determining whether the LSS is associated with a first speed mode or a second speed mode in accordance with a duration between receiving the first signal and the second signal; and performing the LSS in accordance with the first speed mode in response to determining that the duration between receiving the first signal and the second signal satisfies a first threshold.

Aspect 2: The method, apparatus, or non-transitory computer-readable medium of aspect 1, where performing the LSS in accordance with the first speed mode includes operations, features, circuitry, logic, means, or instructions, or any combination thereof for initializing the memory system to operate in accordance with the first speed mode.

Aspect 3: The method, apparatus, or non-transitory computer-readable medium of any of aspects 1 through 2, further including operations, features, circuitry, logic, means, or instructions, or any combination thereof for performing one or more operations in accordance with the first speed mode after initializing the memory system to operate in accordance with the first speed mode.

Aspect 4: The method, apparatus, or non-transitory computer-readable medium of any of aspects 1 through 3, further including operations, features, circuitry, logic, means, or instructions, or any combination thereof for receiving a third signal and a fourth signal associated with a second LSS; determining whether the second LSS is associated with the first speed mode or the second speed mode in accordance with a second duration between receiving the third signal and the fourth signal; determining that the second duration between receiving the third signal and the fourth signal satisfies a second threshold; and performing the second LSS in accordance with the second speed mode in response to determining that the second duration between receiving the third signal and the fourth signal satisfies the second threshold.

Aspect 5: The method, apparatus, or non-transitory computer-readable medium of any of aspects 1 through 4, where the first signal and the second signal are received via a channel coupled with the memory system and a host system and the method, apparatuses, and non-transitory computer-readable medium further includes operations, features, circuitry, logic, means, or instructions, or any combination thereof for determining the duration between receiving the first signal and receiving the second signal.

Aspect 6: The method, apparatus, or non-transitory computer-readable medium of aspect 5, where the first signal and the second signal are associated with initiating the LSS.

Aspect 7: The method, apparatus, or non-transitory computer-readable medium of any of aspects 5 through 6, further including operations, features, circuitry, logic, means, or instructions, or any combination thereof for initiating a timer in response to receiving the first signal and stopping the timer in response to receiving the second signal and determining that the channel has transitioned from a first state to a second state, where the duration corresponds to a value of the timer after stopping the timer.

Aspect 8: The method, apparatus, or non-transitory computer-readable medium of aspect 7, where the channel is operating in accordance with the first state during a period of time in which the first signal and the second signal are received.

Aspect 9: The method, apparatus, or non-transitory computer-readable medium of any of aspects 1 through 8, where the first speed mode includes a high speed mode and the second speed mode includes a low speed mode.

Aspect 10: The method, apparatus, or non-transitory computer-readable medium of any of aspects 1 through 9, where the first speed mode includes a low speed mode and the second speed mode includes a high speed mode.

Aspect 11: The method, apparatus, or non-transitory computer-readable medium of any of aspects 1 through 10, where performing the LSS includes operations, features, circuitry, logic, means, or instructions, or any combination thereof for transmitting a fifth signal to a host system in accordance with performing the LSS, the fifth signal indicating that the memory system performed the LSS in accordance with the first speed mode.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first signal and a second signal each associated with a link startup sequence;
determine whether the link startup sequence is associated with a first speed mode or a second speed mode in accordance with a duration between receiving the first signal and the second signal; and
perform the link startup sequence in accordance with the first speed mode in response to determining that the duration between receiving the first signal and the second signal satisfies a first threshold.

2. The memory system of claim 1, wherein performing the link startup sequence in accordance with the first speed mode comprises the processing circuitry configured to cause the memory system to:
initialize the memory system to operate in accordance with the first speed mode.

3. The memory system of claim 1, wherein the processing circuitry is further configured to cause the memory system to:
perform one or more operations in accordance with the first speed mode after initializing the memory system to operate in accordance with the first speed mode.

4. The memory system of claim 1, wherein the processing circuitry is further configured to cause the memory system to:
receive a third signal and a fourth signal associated with a second link startup sequence;
determine whether the second link startup sequence is associated with the first speed mode or the second speed mode in accordance with a second duration between receiving the third signal and the fourth signal;
determine that the second duration between receiving the third signal and the fourth signal satisfies a second threshold; and
perform the second link startup sequence in accordance with the second speed mode in response to determining that the second duration between receiving the third signal and the fourth signal satisfies the second threshold.

5. The memory system of claim 1, wherein the first signal and the second signal are received via a channel coupled with the memory system and a host system, and the processing circuitry is further configured to cause the memory system to:
determine the duration between receiving the first signal and receiving the second signal.

6. The memory system of claim 5, wherein the first signal and the second signal are associated with initiating the link startup sequence.

7. The memory system of claim 5, wherein the processing circuitry is further configured to cause the memory system to:
initiate a timer in response to receiving the first signal; and
stop the timer in response to receiving the second signal and determining that the channel has transitioned from a first state to a second state, wherein the duration corresponds to a value of the timer after stopping the timer.

8. The memory system of claim 7, wherein the channel is operating in accordance with the first state during a period of time in which the first signal and the second signal are received.

9. The memory system of claim 1, wherein the first speed mode comprises a high speed mode and the second speed mode comprises a low speed mode.

10. The memory system of claim 1, wherein the first speed mode comprises a low speed mode and the second speed mode comprises a high speed mode.

11. The memory system of claim 1, wherein performing the link startup sequence comprises the processing circuitry configured to cause the memory system to:
transmit a fifth signal to a host system in accordance with performing the link startup sequence, the fifth signal indicating that the memory system performed the link startup sequence in accordance with the first speed mode.

12. A non-transitory computer-readable medium storing code comprising instructions which, when executed by processing circuitry of a memory system, cause the memory system to:
receive a first signal and a second signal each associated with a link startup sequence;
determine whether the link startup sequence is associated with a first speed mode or a second speed mode in accordance with a duration between receiving the first signal and the second signal; and
perform the link startup sequence in accordance with the first speed mode in response to determining that the duration between receiving the first signal and the second signal satisfies a first threshold.

13. The non-transitory computer-readable medium of claim 12, wherein the instructions to perform the link startup sequence in accordance with the first speed mode, when executed by the processing circuitry of the memory system, cause the memory system to:
initialize the memory system to operate in accordance with the first speed mode.

14. The non-transitory computer-readable medium of claim 12, wherein the instructions, when executed by the processing circuitry of the memory system, further cause the memory system to:
perform one or more operations in accordance with the first speed mode after initializing the memory system to operate in accordance with the first speed mode.

15. The non-transitory computer-readable medium of claim 12, wherein the instructions, when executed by the processing circuitry of the memory system, further cause the memory system to:
receive a third signal and a fourth signal associated with a second link startup sequence;
determine whether the second link startup sequence is associated with the first speed mode or the second speed mode in accordance with a second duration between receiving the third signal and the fourth signal;
determine that the second duration between receiving the third signal and the fourth signal satisfies a second threshold; and
perform the second link startup sequence in accordance with the second speed mode in response to determining that the second duration between receiving the third signal and the fourth signal satisfies the second threshold.

16. The non-transitory computer-readable medium of claim 12, wherein the first signal and the second signal are received via a channel coupled with the memory system and a host system, and wherein the instructions, when executed by the processing circuitry of the memory system, further cause the memory system to:
determine the duration between receiving the first signal and receiving the second signal.

17. The non-transitory computer-readable medium of claim 16, wherein the first signal and the second signal are associated with initiating the link startup sequence.

18. The non-transitory computer-readable medium of claim 16, wherein the instructions, when executed by the processing circuitry of the memory system, further cause the memory system to:
initiate a timer in response to receiving the first signal; and
stop the timer in response to receiving the second signal and determining that the channel has transitioned from a first state to a second state, wherein the duration corresponds to a value of the timer after stopping the timer.

19. The non-transitory computer-readable medium of claim 18, wherein the channel is operating in accordance with the first state during a period of time in which the first signal and the second signal are received.

20. The non-transitory computer-readable medium of claim 12, wherein the first speed mode comprises a high speed mode and the second speed mode comprises a low speed mode.

21. The non-transitory computer-readable medium of claim 12, wherein the first speed mode comprises a low speed mode and the second speed mode comprises a high speed mode.

22. The non-transitory computer-readable medium of claim 12, wherein the instructions to perform the link startup sequence, when executed by the processing circuitry of the memory system, cause the memory system to:
transmit a fifth signal to a host system in accordance with performing the link startup sequence, the fifth signal indicating that the memory system performed the link startup sequence in accordance with the first speed mode.

23. A method by a memory system, comprising:
receiving a first signal and a second signal each associated with a link startup sequence;
determining whether the link startup sequence is associated with a first speed mode or a second speed mode in accordance with a duration between receiving the first signal and the second signal; and
performing the link startup sequence in accordance with the first speed mode in response to determining that the duration between receiving the first signal and the second signal satisfies a first threshold.

24. The method of claim 23, wherein performing the link startup sequence in accordance with the first speed mode comprises:
initializing the memory system to operate in accordance with the first speed mode.

25. The method of claim 23, further comprising:
performing one or more operations in accordance with the first speed mode after initializing the memory system to operate in accordance with the first speed mode.
